(19) United States
(12) Patent Application Publication
(10) Pub. No.: US 2025/0181475 A1
(43) Pub. Date: Jun. 5, 2025

(54) SYSTEMS AND METHODS FOR DETERMINING USER INTEREST WHILE MAINTAINING PRIVACY

(71) Applicant: Capital One Services, LLC, McLean, VA (US)

(72) Inventors: Joshua EDWARDS, Philadelphia, PA (US); Michael MOSSOBA, Great Falls, VA (US); Tyler MAIMAN, Melville, NY (US)

(73) Assignee: Capital One Services, LLC, McLean, VA (US)

(21) Appl. No.: 18/524,493

(22) Filed: Nov. 30, 2023

(51) Int. Cl. G06F 11/34; G06F 9/445

(52) U.S. Cl. CPC G06F 11/3438; G06F 9/44526

(57) ABSTRACT

A software module, executed locally on a user device, may monitor a plurality of user interactions with one or more interfaces. The plurality of user interactions may be exclusive of item level data of the one or more interfaces. The plurality of user interactions may be provided to a machine-learning model. The machine-learning model may have been trained to identify user interest behavior patterns and output a user interest score. The machine-learning model may output the user interest score based on the plurality of user interactions. It may be determined that the user interest score exceeds a user interest score threshold. A capturing of the item level data of the one or more interfaces may be triggered based on the user interest score exceeding the user interest score threshold. The item level data of the one or more interfaces may be stored locally on the user device.

### TECHNICAL FIELD

Various embodiments of this disclosure relate generally to machine-learning-based techniques for securely determining associations between user interactions, and, more particularly, to systems and methods for determining user interest based on the user interactions.

### BACKGROUND

Determining what content a user is interested in may help to tailor offerings to those that may be relevant to the particular user. Current systems and methods may monitor user behaviors (e.g., web browsing) and use the gathered information from that monitoring to select and present offerings and/or additional content that is relevant to the particular user. However, because of privacy concerns or the like, a user may not be comfortable with a third-party monitoring and/or storing their web traffic and browsing. Therefore, maintaining the privacy of the user while determining the user's interests may be desired.

The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for determining user guidance based on longevity.

In one aspect, an exemplary embodiment of a method for determining user interest may include monitoring, by a software module executed locally on a user device, a plurality of user interactions with one or more interfaces. The plurality of user interactions may be exclusive of item level data of the one or more interfaces. The method may further include providing the plurality of user interactions to a machine-learning model. The machine-learning model may have been trained, using one or more gathered and/or simulated sets of user interactions, to identify user interest behavior patterns and output a user interest score. The method may further include outputting, by the machine-learning model, the user interest score based on the plurality of user interactions. The method may further include determining that the user interest score exceeds a user interest score threshold. The method may further include triggering a capturing of the item level data of the one or more interfaces based on the user interest score exceeding the user interest score threshold. The item level data of the one or more interfaces may be stored locally on the user device.

In another aspect, an exemplary embodiment of training a machine-learning model may include providing one or more gathered and/or simulated sets of user interactions to one or more machine-learning algorithms as one or more sets of training data. The method may further include determining, by the one or more machine-learning algorithms, associations between the one or more gathered and/or simulated sets of user interactions and one or more user interest behavior patterns. The method may further include modifying one or more of a layer, a weight, a synapse, or a node of a machine-learning model based on the associations between the one or more gathered and/or simulated sets of user interactions and one or more user interest behavior patterns. The method may further include outputting the machine-learning model. The machine-learning model may have been trained to identify user interest behavior patterns based on a plurality of user interactions and output a user interest score based on the plurality of user interactions and the modified one or more of the layer, the weight, the synapse, or the node of the machine-learning model.

In a further aspect, an exemplary embodiment of a system for determining user interest may include a memory storing instructions and a trained machine-learning model having been trained to identify user interest behavior patterns and output a user interest score, and a processor operatively connected to the memory and configured to execute the instructions to perform operations. The operations may include monitoring, by a software module executed locally on a user device, a plurality of user interactions with one or more interfaces. The plurality of user interactions may be exclusive of item level data of the one or more interfaces. The operations may further include providing the plurality of user interactions to a machine-learning model. The machine-learning model may have been trained, using one or more gathered and/or simulated sets of user interactions, to identify user interest behavior patterns and output a user interest score. The operations may further include outputting, by the machine-learning model, the user interest score based on the plurality of user interactions. The operations may further include determining that the user interest score exceeds a user interest score threshold. The operations may further include triggering a capturing of the item level data of the one or more interfaces based on the user interest score exceeding the user interest score threshold. The item level data of the one or more interfaces may be stored locally on the user device.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for using a machine-learning model to determine user interest, according to one or more embodiments.

FIG. 2 depicts a block diagram of a monitoring of user interactions, according to one or more embodiments.

FIG. 3 depicts a flowchart of an exemplary method of using a user interest system, according to one or more embodiments.

FIG. 4 depicts a flowchart of an exemplary method of training a machine-learning model of the user interest system, according to one or more embodiments.

FIG. 5 depicts a flow diagram for training a machine-learning model, according to one or more embodiments.

FIG. 6 depicts an example of a computing device, according to one or more embodiments.

### DETAILED DESCRIPTION OF EMBODIMENTS

According to certain aspects of the disclosure, methods and systems are disclosed for determining user interest based on finding associations in user interactions. Users may benefit from relevancy of content. However, conventional techniques may not be suitable. Conventional monitoring of user interactions may contribute to privacy concerns, as well as inefficiency concerns, if a user's interactions (e.g., web browsing) are constantly monitored. Accordingly, improvements in the technology relating to determining user interest are needed. The present disclosure, among other things, provides for the monitoring to occur at times that are relevant to determining a user's interests.

As will be discussed in more detail below, in various embodiments, systems and methods are described for using machine-learning to determine user interest. By training a machine-learning model (e.g., via supervised or semi-supervised learning), to learn associations between user interactions (e.g., web traffic, browsing, and/or user behavior), the trained machine-learning model may be usable to determine user interest and if item level data should be captured. User interactions may be monitored locally on a user device until the machine-learning model determines that user interest has exceeded a threshold. Then, capturing of item level data may occur to present relevant content for the user.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially,” “approximately,” and “generally,” are used to indicate a possible variation of +10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Terms like “provider,” “merchant,” “vendor,” or the like generally encompass an entity or person involved in providing, selling, and/or renting items to persons such as a seller, dealer, renter, merchant, vendor, or the like, as well as an agent or intermediary of such an entity or person. An “item” generally encompasses a good, service, or the like having ownership or other rights that may be transferred. As used herein, terms like “user” or “customer” generally encompasses any person or entity that may desire information, resolution of an issue, purchase of a product, or engage in any other type of interaction with a provider. The term “browser extension” may be used interchangeably with other terms like “program,” “electronic application,” or the like, and generally encompasses software that is configured to interact with, modify, override, supplement, or operate in conjunction with other software. As used herein, terms such as “guidance” or the like generally encompass one or more recommendations.

As used herein, a “machine-learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine-learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine-learning model may operate on an input linearly, in parallel, via a network (e.g., a neural network), or via any suitable configuration.

The execution of the machine-learning model may include deployment of one or more machine-learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

In an exemplary use case, a machine-learning algorithm may be configured to train a machine-learning model by modifying one or more of a weight, a layer, a node, and/or a synapse of the machine-learning model such that the machine-learning model may be configured to identify user interest behavior patterns and output a user interest score.

In another exemplary use case, an unsupervised machine-learning model may be trained to identify or detect that a user has interest in a webpage or web content. When the interest is identified, a user may be given an opportunity to confirm that interest (e.g., by clicking on a pop-up asking if the user is interested in the content, or the like). Using this data, a supervised machine-learning model may be trained to identify or detect user interest and to output a user interest score.

While the examples above involve determining user interest, it should be understood that techniques according to this disclosure may be adapted to any suitable type of determining interest. It should also be understood that the examples herein are illustrative only. The techniques and technologies of this disclosure may be adapted to any suitable activity.

As used herein, and as discussed in greater detail below, “interest” may refer to involvement, association and/or desire of a user that may be inferred or indicated via a pattern of behaviors with which a user interacts with particular content via an interface. For example, a machine-learning model may be trained, using one or more gathered and/or simulated sets of user interactions, to identify behavior patterns indicative of user interest, referred to herein as user interest behavior patterns, and output a user interest score, e.g., a likelihood that the user is interested in content being interacted with, or a value associated with the same. In an example, such user interactions may include selection of buttons, scrolling, pausing on the display of content, reopening a tab, and the like.

Presented below are also various aspects of machine-learning techniques that may be adapted to determining user interest. As will be discussed in more detail below, machine-learning techniques adapted to determining user interest, may include one or more aspects according to this disclosure, e.g., finding associations between a particular selection of training data, a particular training process for the machine-learning model, operation of a particular device suitable for use with the trained machine-learning model, operation of the machine-learning model in conjunction with particular data, modification of such particular data by the machine-learning model, etc., and/or other aspects that may be apparent to one of ordinary skill in the art based on this disclosure.

Conventional monitoring of user interactions may contribute to privacy concerns, as well as inefficiency concerns, if a user's interactions (e.g., web browsing) are constantly monitored. Therefore, presented below are also various aspects of a user interest system. A software module executed locally on a user device may monitor user interactions with one or more user interfaces, such as webpages. Item level data may not be monitored with the user interactions in order to protect the user's privacy. Instead, the user interactions may be provided to a machine-learning model. The machine-learning model may have been trained, using one or more gathered and/or simulated sets of user interactions, to identify user interest behavior patterns within the user interactions and output a user interest score that may represent a level of user interest. If the user interest score exceeds a user interest score threshold (e.g., the user's interest rises to a certain level), a capturing of the item level data of the one or more interfaces may only then be triggered. Still, the item level data of the one or more interfaces may be stored locally on the user device in order to continue to protect user privacy while still determining user interest.

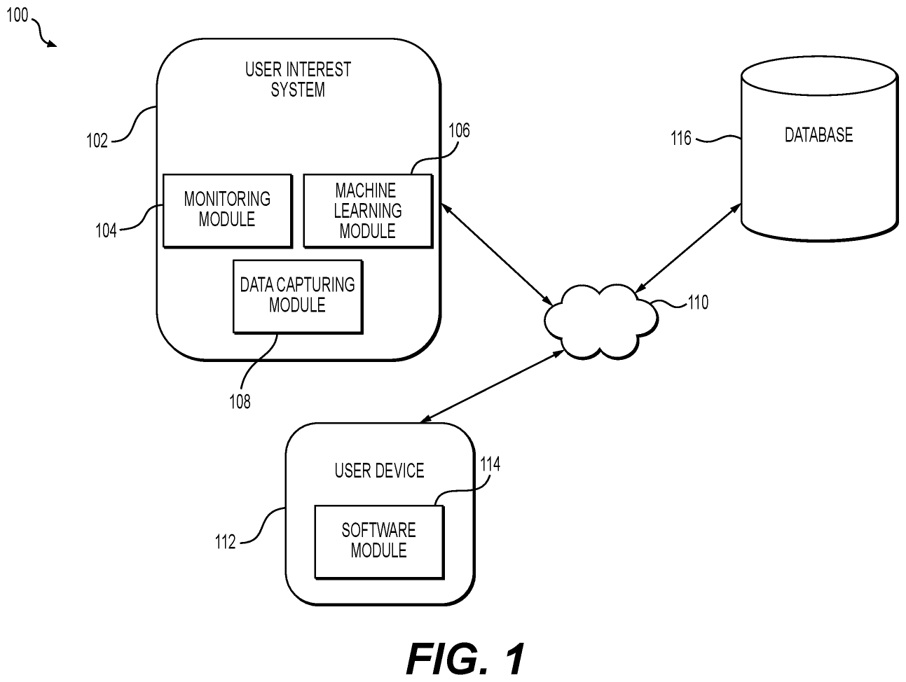

FIG. 1 depicts an exemplary environment 100 that may be utilized with techniques presented herein. One or more user device(s) 112 may communicate across an electronic network 110. As will be discussed in further detail below, one or more user interest system(s) 102 may communicate with one or more of the other components of the environment 100 across electronic network 110. The one or more user device(s) 112 may be associated with a user, e.g., a user associated with one or more of generating, training, or tuning a machine-learning model for determining user interest, identifying user interest behavior patterns, and/or output a user interest score. The one or more user device(s) 112 may also be associated with a user that is interacting with, or has interacted with (e.g., by user interactions), content presented or displayed on user device(s) 112.

In some embodiments, the components of the environment 100 are associated with a common entity, e.g., a financial institution, transaction processor, merchant, vendor, content provider, or the like. In some embodiments, one or more of the components of the environment is associated with a different entity than another. The systems and devices of the environment 100 may communicate in any arrangement. As will be discussed herein, systems and/or devices of the environment 100 may communicate in order to one or more of generate, train, or use a machine-learning model to identify user interest behavior patterns, and/or output a user interest score, among other activities.

The user device(s) 112 may be configured to enable a user to access and/or interact with other systems in the environment 100. For example, the user device(s) 112 may be a computer system such as, for example, a desktop computer, a mobile device, a tablet, etc. In some embodiments, the user device(s) 112 may include one or more electronic application(s), e.g., a program, plugin, browser extension, etc., installed on a memory of the user device(s) 112. In some embodiments, the electronic application(s) may be associated with one or more of the other components in the environment 100. For example, the electronic application(s) may include one or more of a program, plugin, browser extension, etc.

The user device(s) 112 may include software module 114. Software module 114 may include a program, plugin, browser extension, or the like, stored locally on user device(s) 112. In various embodiments, user interest system(s) 102 may be implemented or run on user device(s) 112 using software module 114. In any case, software module 114 may capture item level data of one or more interfaces of user device(s) 112 based on a user interest score (e.g., determined by a machine-learning model) exceeding a user interest score threshold. In examples, to maintain or protect privacy, the item level data of the one or more interfaces may be captured by locally stored and executed software module 114. The item level data may likewise be stored locally on user device(s) 112. The item level data may include a plurality of attributes of the one or more interfaces of user device(s) 112, text of the one or more interfaces, and/or images of the one or more interfaces. In a particular example, an image of a pair of red shoes may be displayed on the one or more interfaces, along with a text description of the shoes. The item level data of the content related to the shoes, therefore, may include the image(s) of the shoes, metadata associated with the image(s), the text description of the shoes converted to raw data, information about a vendor or merchant associated with the shoes, and the like. As will be described in greater detail below, the item level data may be associated with a user point of interest. Further to the particular example described, user A, or a profile or account of user A, may be associated with a user point of interest of shoes or, more specifically, shoes that match one or more points of relevance to the red shoes displayed in the one or more interfaces with which user A interacted.

In various embodiments, the environment 100 may include a database 116 or datastore. The database 116 may include a server system and/or a data storage system such as computer-readable memory such as a hard drive, flash drive, disk, etc. In some embodiments, the database 116 includes and/or interacts with an application programming interface for exchanging data to other systems, e.g., one or more of the other components of the environment. The database 116 may include and/or act as a repository or source for storing one or more user interactions, user points of interest, data associated with a user profile or account, or the like. For example, the user interactions may be provided as input to a machine-learning model trained to identify user interest behavior patterns and output a user interest score.

In various embodiments, the electronic network 110 may be a wide area network (“WAN”), a local area network (“LAN”), personal area network (“PAN”), or the like. In some embodiments, electronic network 110 includes the Internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

As discussed in further detail below, the user interest system(s) 102 may one or more of (i) generate, store, train, or use a machine-learning model configured to determine user interest and/or identify user interest behavior patterns, and output a user interest score. The user interest system(s) 102 may include a machine-learning model and/or instructions associated with the machine-learning model, e.g., instructions for generating a machine-learning model, training the machine-learning model, using the machine-learning model etc. The user interest system(s) 102 may include instructions for retrieving, monitoring, and/or capturing item level data, adjusting item level data, and/or a user point of interest e.g., based on the output of the machine-learning model, and/or operating a display of the user device(s) 112 to provide output, e.g., as adjusted based on the machine-learning model. The user interest system(s) 102 may include training data, e.g., user interactions, and may include ground truth, e.g., training user interactions, to identify user interest behavior patterns and output a user interest score.

As depicted in FIG. 1, user interest system(s) 102 may include monitoring module 104. In various embodiments, monitoring module 104 is configured to monitor, by a software module executed locally on a user device, a plurality of user interactions with one or more interfaces of user device(s) 112. The plurality of user interactions may be exclusive of item level data of the one or more interfaces. Alternative to being included within user interest system(s) 102, monitoring module 104 may be included within user device(s) 112, such that the monitoring may occur by software module 114, executed locally on user device(s) 112. In still other embodiments, monitoring module may be stored in the cloud (e.g., as accessed via network 110) or stored within user interest system(s) 102, but may be executed locally on user device(s) 112, using software module 114, such that no data (e.g., user interactions are transferred to the cloud. Examples of user interactions that may be monitored include selection of buttons, scrolling, pausing on the display of content, reopening a tab, and the like. The user interactions may then be provided to machine-learning module 106 as input.

User interest system(s) 102 may include machine-learning module 106. In various embodiments, a machine-learning module include a machine-learning model configured to identify user interest behavior patterns and output a user interest score. The machine-learning model may be trained using one or more gathered and/or simulated sets of user interactions. For example, a user interest machine-learning model may learn to associate particular user interactions with user interest, such as clicking on a link or interactive button, reopening of a tab, and the like. Furthermore, the user interest machine-learning model may learn to generate and output a user interest score that is greater relative to the user interest (e.g. the higher the score, the more the user interest). In such examples, a greater amount of user interactions may not always result in a greater user interest score. The user interest machine-learning model may learn to associate particular patterns of behavior with greater user interest. In various embodiments, as these particular patterns of behavior are monitored (e.g., by monitoring module 104), and are input into the user interest machine-learning model (e.g. as a plurality of user interactions), user interest machine-learning model may be able to identify the particular patterns of behavior, associate them with user interest, and output a user interest score. In examples, the machine-learning model may be able to output a user interest score to a degree of confidence despite being provided different types of user interactions in different instances or cases.

As illustrated, user interest system(s) 102 may also include data capturing module 108. In various embodiments, data capturing module 108 is configured to determine that the user interest score exceeds a user interest score threshold and to therefore trigger the capturing of the item level data of the one or more interfaces of user device(s) 112 based on the user interest score exceeding the user interest score threshold. In examples, the item level data of the one or more interfaces may be stored locally on the user device(s) 112, or it may be transmitted to database 116 via network 110. In examples, and as described, the item level data captured by data capturing module 108 may include a plurality of attributes of the one or more interfaces of user device(s) 112, text of the one or more interfaces, and/or images of the one or more interfaces. In examples, such attributes may include metadata of a webpage or website, browser data, browsing history, a location of the user, a merchant or vendor associated with the webpage or website, input provided by the user, images, formatted or raw text, and the like. In a particular embodiment, data capturing module 108 does not trigger the capturing of item level data unless and/or until the user interest score (e.g. as determined by a machine-learning model) exceeds a user interest score threshold. In examples, the user interest score threshold may be set or determined by a user or another entity (e.g. an administrator of the browser, an administrator of the software module 114, a merchant, a vendor, a financial institution, or the like). The user interest score threshold may be a fixed, predetermined value, or it may be variable or configurable based on a plurality of user interest factors (e.g., date and time, location of a user, a particular entity, a user profile or account, user preferences, an output of a machine-learning model, and the like).

In some embodiments, a system or device other than the user interest system(s) 102 is used to generate and/or train the machine-learning model. For example, such a system may include instructions for generating the machine-learning model, the training data and ground truth, and/or instructions for training the machine-learning model. A resulting trained-machine-learning model may then be provided to the user interest system(s) 102.

Generally, a machine-learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable. In various embodiments, training data may be gathered using an unsupervised machine-learning model configured to identify or detect that a user has interest in a webpage, web content, or the like. When the interest is identified by the unsupervised machine-learning model, a user may be given an opportunity to confirm that interest (e.g., by clicking on a pop-up asking if the user is interested in the content, or the like). Using this gathered data (e.g., the user's interactions and the user's confirmations), a supervised machine-learning model may then be trained to identify or detect user interest and to output a user interest score.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine-learning model, e.g., compare the output of the trained model with the ground truth for that portion of the training data to evaluate an accuracy of the trained model. The training of the machine-learning model may be configured to cause the machine-learning model to learn associations between user interactions, such that the trained machine-learning model is configured to identify user behavior patterns and output a user interest score based on the learned associations. As used herein, user behavior patterns may include patterns found within user interactions, such as revisiting a browser tab a number of times over a period of time, hovering over a particular element(s) for a certain period of time, patterns of scrolling back and forth or up and down, the speed at which a user may scroll the page, clicking of buttons on the page or on the user device, leaving a browser tab open, and the like.

In various embodiments, the variables of a machine-learning model may be interrelated in any suitable arrangement in order to generate the output. For example, in some embodiments, the machine-learning model may include content-processing architecture that is configured to identify, isolate, and/or extract features, geometry, and or structure in one or more of optical character recognition data and/or non-optical in vivo image data. For example, the machine-learning model may include one or more convolutional neural network (“CNN”) configured to identify patterns in user behavior and/or user interactions, and may include further architecture, e.g., a connected layer, neural network, etc., configured to determine a relationship between the identified patterns of behavior in order to output a user interest score.

In some instances, different samples of training data and/or input data may not be independent. For example, samples of training data may include user interactions monitored from users that elect to be monitored for the gathering of such training data, simulated user interactions, user interest scores, and the like. Thus, in some embodiments, the machine-learning model may be configured to account for and/or determine relationships between multiple samples, at times from multiple sources.

For example, in some embodiments, the machine-learning model of the user interest system 102 may include a Recurrent Neural Network (“RNN”). Generally, RNNs are a class of feed-forward neural networks that may be well adapted to processing a sequence of inputs. In some embodiments, the machine-learning model may include a Long Short Term Memory (“LSTM”) model and/or Sequence to Sequence (“Seq2Seq”) model. An LSTM model may be configured to generate an output from a sample that takes at least some previous samples and/or outputs into account. A Seq2Seq model may be configured to, for example, receive a sequence of user interactions as input, and generate a user interest score as output.

Although depicted as separate components in FIG. 1, it should be understood that a component or portion of a component in the environment 100 may, in some embodiments, be integrated with or incorporated into one or more other components. For example, a display may be integrated into the user device 112 or the like. In another example, the user interest system 102 may be integrated in a data storage system. The data storage system may be configured to communicate and/or receive/send data across electronic network 110 to other components of environment 100. Further, user interest system 102 may be integrated or incorporated into software module 114. In some embodiments, operations or aspects of one or more of the components discussed above may be distributed amongst one or more other components. Any suitable arrangement and/or integration of the various systems and devices of the environment 100 may be used.

Further aspects of the machine-learning model and/or how it may be utilized are discussed in further detail in the methods below. In the following methods, various acts may be described as performed or executed by a component from FIG. 1, such as user interest system 102, the user device 112, or components thereof. However, it should be understood that in various embodiments, various components of the environment 100 discussed above may execute instructions or perform acts including the acts discussed below. An act performed by a device may be considered to be performed by a processor, actuator, or the like associated with that device. Further, it should be understood that in various embodiments, various steps may be added, omitted, and/or rearranged in any suitable manner.

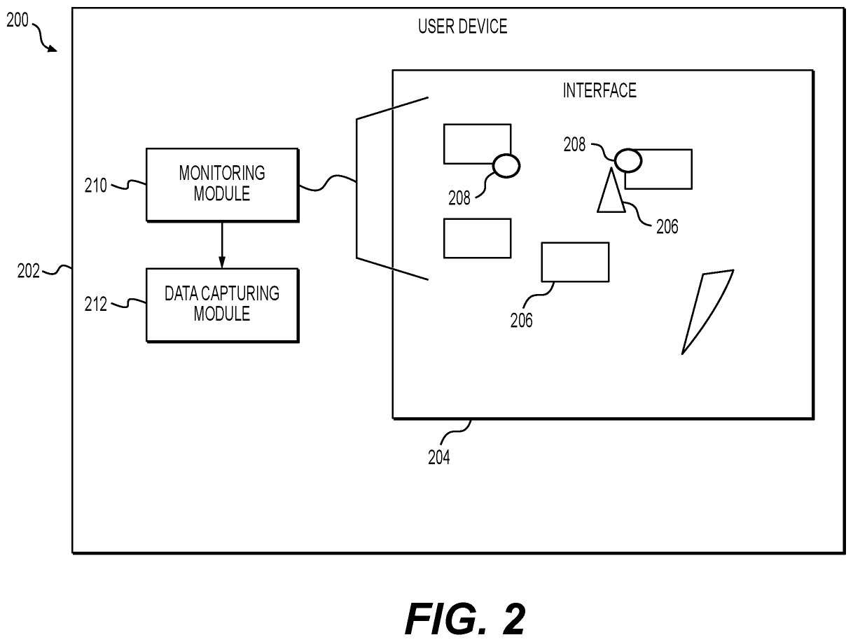

FIG. 2 illustrates a block diagram 200 of a monitoring of user interactions. As illustrated, and in various embodiments, a user device 202 may include an interface 204. Interface 204 may be displayed by or within one or more displays of user device 202 and may be configured as an input/output device (e.g., I/O) or window, capable of receiving input from a user via a peripheral device attached to user device 202 (e.g., keyboard, mouse, joystick), via haptic input (e.g., touchscreen input), or the like. As illustrated, interface 204 may include a plurality of interface objects 206. In examples, interface objects 206 may include attributes of interface 204 with which a user may interact, such as buttons, links, images, text boxes, fillable forms, scroll bars, and the like. User interactions 208 are therefore those interactions with interface objects 206, such as mouse movement, clicking, scrolling, screen capturing, pausing, zooming, bookmarking, and the like.

As described above, with respect to FIG. 1, monitoring module 210 (e.g., of user interest system 102) may be configured to monitor user interactions 208 and to provide user interactions 208 to a machine-learning model. In examples, user interactions 208 are exclusive of item level data. User interactions 208 may include one or more of interactions with one or more links embedded in the one or more interfaces 204, and scrolling the one or more interfaces 204. In various implementations, monitoring module 210 may be integrated within, or executed using, user device 202, although monitoring module 210 may also be accessed by user device 202 and not integrated within user device 202 itself.

As described above, with respect to FIG. 1, data capturing module 212 (e.g., of user interest system 102) may be configured to trigger the capturing of item level data of the interface 204 and/or interface objects 206 based on a user interest score (e.g., as determined by the machine-learning model) exceeding a user interest score threshold. The item level data may include data of a plurality of attributes (e.g., interface objects 206) of the one or more interfaces 204, text of the one or more interfaces 204, and/or images of the one or more interfaces 204. In examples, the item level data of interface 204 is stored locally on the user device 202.

According to an embodiment, user interactions 208 may be provided as inputs into a user interest machine-learning model. The user interest machine-learning model may be trained by modifying one or more weights, layers, nodes, synapses, etc., based on training data that may include historical user interactions, historical item level data, historical user interest scores, simulated user interactions, simulated item level data, simulated user interest scores, and/or the like. The training data may be tagged or untagged (e.g., for supervised, semi-supervised, or unsupervised training). The user interest machine-learning model may generate an output including the user interest score determined based on the input user interactions. Alternatively, or in addition, the user interest machine-learning model may output a user interest confidence score, where the user interest confidence score indicates a level of confidence that an output user interest score represents a true interest of a user. The user interest score may be determined based on the respective user interest confidence score meeting a user interest confidence score threshold. Further, the user interest machine-learning model may determine a user point of interest that may be associated with the item level data of the one or more interfaces, such as interface 204.

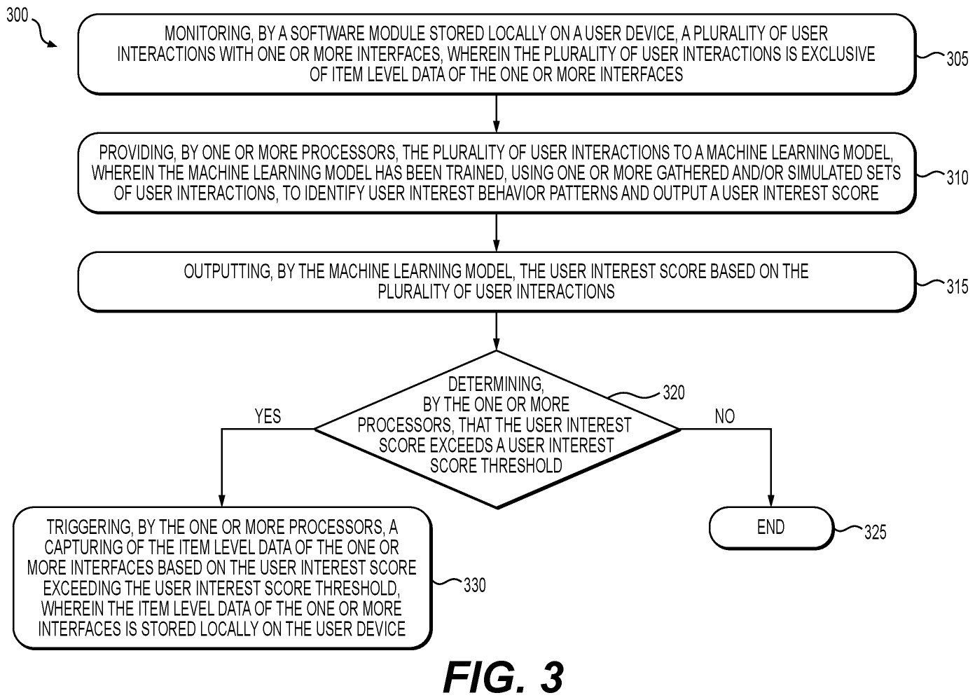

FIG. 3 illustrates an exemplary process 300 for using a user interest system, such as in the various examples discussed herein. At step 305, a plurality of user interactions with one or more interfaces is monitored by a software module stored locally on a user device (e.g., such as software module 114, as depicted in FIG. 1). In examples, a monitoring module (e.g., such as monitoring module 104, as depicted in FIG. 1) is implemented by the software module. The plurality of user interactions may be exclusive of item level data of the one or more interfaces. At step 310, the plurality of user interactions is provided to a machine learning model. The machine learning model may be trained, using any one of the mechanisms described herein, to identify user interest behavior patterns and to output a user interest score. In examples, the user interactions may be provided to a machine-learning module that implements the machine-learning model (e.g., machine-learning module 106, as depicted in FIG. 1). At step 315, the user interest score is output by the machine-learning model based on the plurality of user interactions.

At step 320, it may be determined whether or not the user interest score exceeds a user interest score threshold. If the user interest score does not exceed the user interest score threshold, then, at step 325, exemplary process 300 ends. If the user interest score does exceed the user interest score threshold, then, at step 330, a capturing of the item level data of the one or more interfaces is triggered based on the user interest score exceeding the user interest score threshold. The capturing of the item level data may be performed by a data capturing module (e.g., data capturing module 108, as depicted in FIG. 1). The capturing of the item level data may be for a predetermined amount of time. For example, when the user interest score exceeds the user interest score threshold, the item level data may be captured for 5 minutes, 1 hour, 1 day, 1 week, or any period of time. The period of time may be fixed or variable and/or configurable based on a number of factors, such as user preference, entity preference, or the like. The item level data of the one or more interfaces may be stored locally on the user device. The item level data of the one or more interfaces may also be associated with a user point of interest. An element associated with the user point of interest may be output to an output device of the user (e.g., to user device(s) 112, as depicted in FIG. 1). In examples, the element may be a pair of red shoes based upon a user point of interest associated with red shoes.

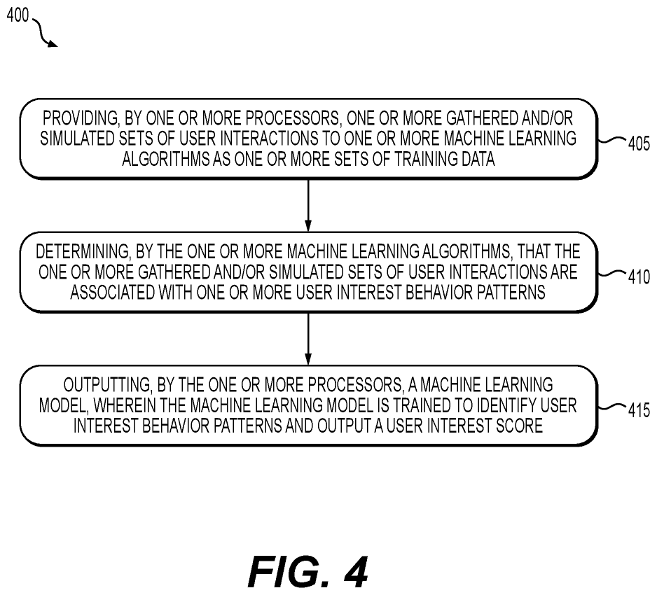

FIG. 4 illustrates another exemplary process 400 for training a machine-learning model of the user interest system, according to one or more embodiments discussed above, such as those discussed with respect to FIG. 1. At step 405, one or more gathered and/or simulated sets (e.g., using an unsupervised machine-learning model) of user interactions may be provided to one or more machine-learning algorithms as one or more sets of training data. In examples, the one or more gathered and/or simulated sets of user interactions may include one or more of interactions with one or more links embedded in the one or more interfaces and scrolling the one or more interfaces. At step 410, it may be determined, by the one or more machine-learning algorithms, that the one or more gathered and/or simulated sets of user interactions are associated with one or more user interest behavior patterns. At step 415, a machine-learning model (e.g., a user interest machine-learning model) is output. The machine-learning model may be trained to identify user interest behavior patterns and to output a user interest score. The machine-learning model may be the machine-learning model utilized in exemplary process 300, as depicted in FIG. 3, for determining user interest.

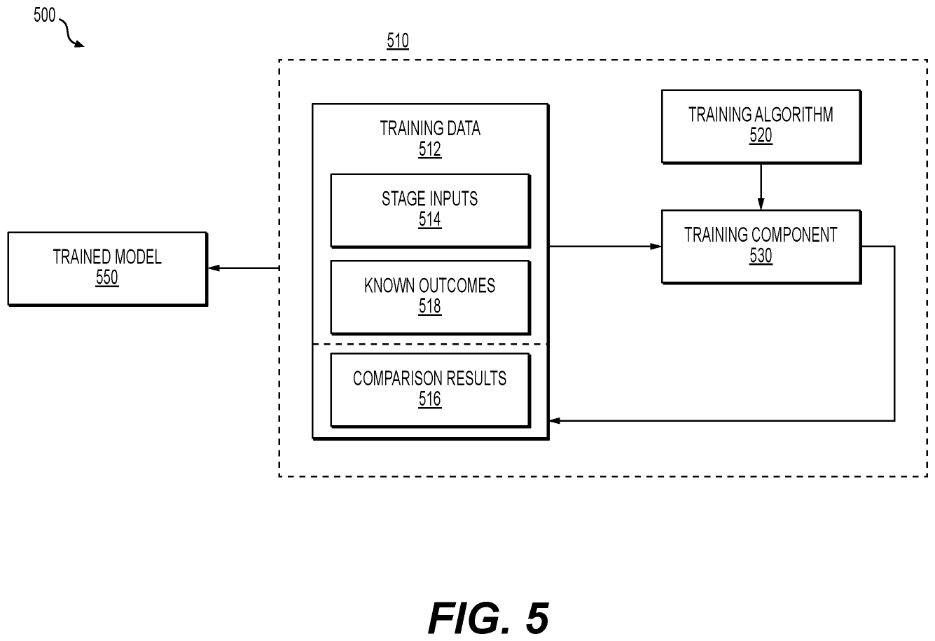

As disclosed herein, one or more implementations disclosed herein may be applied by using a machine-learning model. A machine-learning model as disclosed herein may be trained using one or more components or steps of FIGS. 1-4. As shown in flow diagram 500 of FIG. 5, in a training 510 of the machine-learning model, training data 512 may include one or more of stage inputs 514 and known outcomes 518 related to a machine-learning model to be trained. The stage inputs 514 may be from any applicable source including a component or set shown in the figures provided herein. The known outcomes 518 may be included for machine-learning models generated based on supervised or semi-supervised training. An unsupervised machine-learning model might not be trained using known outcomes 518. Known outcomes 518 may include known or desired outputs for future inputs similar to or in the same category as stage inputs 514 that do not have corresponding known outputs.

The training data 512 and a training algorithm 520 may be provided to a training component 530 that may apply the training data 512 to the training algorithm 520 to generate a trained machine-learning model 550. According to an implementation, the training component 530 may be provided comparison results 516 that compare a previous output of the corresponding machine-learning model to apply the previous result to re-train the machine-learning model. The comparison results 516 may be used by the training component 530 to update the corresponding machine-learning model. The training algorithm 520 may utilize machine-learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 500 (e.g., the training 510) may be a trained machine-learning model 550.

A machine-learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine-learning model (e.g., a trained model) based on the training. Once trained, the machine-learning model may output machine-learning model outputs in accordance with the subject matter disclosed herein. According to an implementation, one or more machine-learning models disclosed herein may continuously update based on feedback associated with use or implementation of the machine-learning model outputs.

It should be understood that embodiments in this disclosure are exemplary only, and that other embodiments may include various combinations of features from other embodiments, as well as additional or fewer features. For example, while some of the embodiments above pertain to multipartite relay, any suitable activity may be used.

In general, any process or operation discussed in this disclosure that is understood to be computer-implementable, such as the processes illustrated in the flowcharts disclosed herein, may be performed by one or more processors of a computer system, such as any of the systems or devices in the exemplary environments disclosed herein, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a system or device implementing a process or operation in the examples above, may include one or more computing devices, such as one or more of the systems or devices disclosed herein. One or more processors of a computer system may be included in a single computing device or distributed among a plurality of computing devices. A memory of the computer system may include the respective memory of each computing device of the plurality of computing devices.

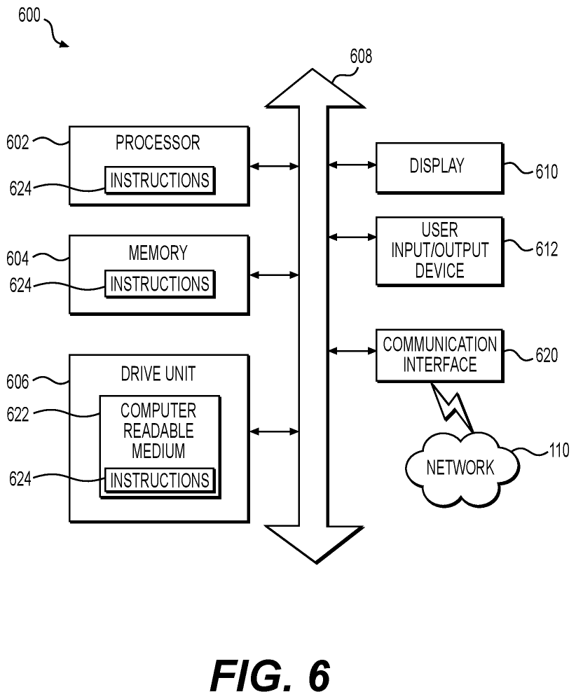

FIG. 6 is a simplified functional block diagram of a computer 600 that may be configured as a device for executing the methods disclosed here, according to exemplary embodiments of the present disclosure. For example, the computer 600 may be configured as a system according to exemplary embodiments of this disclosure. In various embodiments, any of the systems herein may be a computer 600 including, for example, a data communication interface 620 for packet data communication. The computer 600 also may include a central processing unit (“CPU”) 602, in the form of one or more processors, for executing program instructions. The computer 600 may include an internal communication bus 608, and a storage unit 606 (such as ROM, HDD, SDD, etc.) that may store data on a computer readable medium 622, although the computer 600 may receive programming and data via network communications. The computer 600 may also have a memory 604 (such as RAM) storing instructions 624 for executing techniques presented herein, although the instructions 624 may be stored temporarily or permanently within other modules of computer 600 (e.g., processor 602 and/or computer readable medium 622). The computer 600 also may include input and output ports 612 and/or a display 610 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

While the disclosed methods, devices, and systems are described with exemplary reference to transmitting data, it should be appreciated that the disclosed embodiments may be applicable to any environment, such as a desktop or laptop computer, an automobile entertainment system, a home entertainment system, etc. Also, the disclosed embodiments may be applicable to any type of Internet protocol.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for determining user interest, comprising:
monitoring, by a software module executed locally on a user device, a plurality of user interactions with one or more interfaces, the plurality of user interactions being exclusive of item level data of the one or more interfaces;
providing, by one or more processors, the plurality of user interactions to a machine-learning model, wherein the machine-learning model has been trained, using one or more gathered and/or simulated sets of user interactions, to identify user interest behavior patterns and output a user interest score;
outputting, by the machine-learning model, the user interest score based on the plurality of user interactions;
determining, by the one or more processors, that the user interest score exceeds a user interest score threshold; and
triggering, by the one or more processors, a capturing of the item level data of the one or more interfaces based on the user interest score exceeding the user interest score threshold, wherein the item level data of the one or more interfaces is stored locally on the user device.

2. The computer-implemented method of claim 1, wherein the software module executed locally on the user device is one of an extension or a plugin.

3. The computer-implemented method of claim 1, wherein the plurality of user interactions comprise one or more of interactions with one or more links embedded in the one or more interfaces or scrolling the one or more interfaces.

4. The computer-implemented method of claim 1, wherein the item level data comprises a plurality of attributes of the one or more interfaces, text of the one or more interfaces, and/or images of the one or more interfaces.

5. The computer-implemented method of claim 1, further comprising associating the item level data of the one or more interfaces with a user point of interest.

6. The computer-implemented method of claim 5, further comprising outputting, by the one or more processors, to an output device of the user, an element associated with the user point of interest.

7. The computer-implemented method of claim 1, wherein the item level data of the one or more interfaces is captured for a predetermined amount of time.

8. A computer-implemented method for training a machine-learning model for determining user interest, comprising:
providing, by one or more processors, one or more gathered and/or simulated sets of user interactions to one or more machine-learning algorithms as one or more sets of training data;
determining, by the one or more machine-learning algorithms, associations between the one or more gathered and/or simulated sets of user interactions and one or more user interest behavior patterns;
modifying one or more of a layer, a weight, a synapse, or a node of a machine-learning model based on the associations between the one or more gathered and/or simulated sets of user interactions and one or more user interest behavior patterns; and
outputting, by the one or more processors, the machine-learning model, wherein the machine-learning model is trained to identify user interest behavior patterns based on a plurality of user interactions and output a user interest score based on the plurality of user interactions and the modified one or more of the layer, the weight, the synapse, or the node of the machine-learning model.

9. The computer-implemented method of claim 8, wherein the one or more gathered and/or simulated sets of user interactions comprise one or more of interactions with one or more links embedded in one or more interfaces or scrolling the one or more interfaces.

10. The computer-implemented method of claim 8, further comprising monitoring, by a software module stored locally on a user device, the plurality of user interactions with one or more interfaces, wherein the plurality of user interactions is exclusive of item level data of the one or more interfaces.

11. The computer-implemented method of claim 10, further comprising:
providing, by one or more processors, the plurality of user interactions to the machine-learning model; and
outputting, by the machine-learning model, the user interest score based on the plurality of user interactions.

12. The computer-implemented method of claim 11, further comprising triggering, by the one or more processors, a capturing of the item level data of the one or more interfaces based on the user interest score exceeding a user interest score threshold, wherein the item level data of the one or more interfaces is stored locally on the user device.

13. The computer-implemented method of claim 8, further comprising gathering, by a second machine-learning model, the one or more gathered and/or simulated sets of user interactions.

14. A system for determining user interest, comprising:
a memory storing instructions and a trained machine-learning model trained to identify user interest behavior patterns and output a user interest score; and
a processor operatively connected to the memory and configured to execute the instructions to perform operations including:
monitoring, by a software module executed locally on a user device, a plurality of user interactions with one or more interfaces, the plurality of user interactions being exclusive of item level data of the one or more interfaces;
providing, by one or more processors, the plurality of user interactions to a machine-learning model, wherein the machine-learning model has been trained, using one or more gathered and/or simulated sets of user interactions, to identify user interest behavior patterns and output a user interest score;
outputting, by the machine-learning model, the user interest score based on the plurality of user interactions;
determining, by the one or more processors, that the user interest score exceeds a user interest score threshold; and
triggering, by the one or more processors, a capturing of the item level data of the one or more interfaces based on the user interest score exceeding the user interest score threshold, wherein the item level data of the one or more interfaces is stored locally on the user device.

15. The system of claim 14, wherein the software module stored locally on the user device is one of an extension or a plugin.

16. The system of claim 14, wherein the plurality of user interactions comprise one or more of interactions with one or more links embedded in the one or more interfaces and scrolling the one or more interfaces.

17. The system of claim 14, wherein the item level data comprises a plurality of attributes of the one or more interfaces, text of the one or more interfaces, and/or images of the one or more interfaces.

18. The system of claim 14, further comprising associating the item level data of the one or more interfaces with a user point of interest.

19. The system of claim 18, further comprising outputting, by the one or more processors, to an output device of the user, an element associated with the user point of interest.

20. The system of claim 14, wherein the item level data of the one or more interfaces is captured for a predetermined amount of time.
